(19) United States
(12) Patent Application Publication
(10) Pub. No.: US 2014/0224605 A1
(43) Pub. Date: Aug. 14, 2014

(54) Suspension Module

(71) Applicant: TRELLEBORG INDUSTRIAL PRODUCTS USA, INC., South Haven, MI (US)

(72) Inventor: Donald M. Farbotnik, Waterford, PA (US)

(73) Assignee: TRELLEBORG INDUSTRIAL PRODUCTS USA, INC., South Haven, MI (US)

(21) Appl. No.: 14/177,985

(22) Filed: Feb. 11, 2014

(30) Foreign Application Priority Data
Feb. 11, 2013 (GB) 1302391.6

(51) Int. Cl. F16F 9/48; F16F 9/346; F16F 9/18

(52) U.S. Cl. CPC F16F 9/48; F16F 9/18; F16F 9/346
USPC 188/286

(57) ABSTRACT

A damper for use in a suspension module comprises an inner member and an outer member. The inner member traverses axially through a fluid-tight chamber formed between the members and containing damper fluid. Inside the chamber, a piston is axially displaceable between a pair of abutment surfaces. A permanent passage allows the damper fluid to pass from one side of the piston to the other. Also, when the piston is part way between the abutment surfaces, an auxiliary passage is open through which the damper fluid can pass from one side of the piston to the other. The auxiliary passage is blocked by the piston when it abuts against one of the abutment surfaces. The damper may be used in vibration isolation mounts for a driver cabin in off-road vehicles.

### CROSS REFERENCE TO RELATED APPLICATIONS

This application claims the priority benefit of United Kingdom patent application, no. GB1302391.6, entitled “SUSPENSION MODULE”, which was filed on Feb. 11, 2013, the contents of which are incorporated in their entirety by reference.

### BACKGROUND

Disclosed herein is a suspension module, particularly one that may be retro-fitted, or incorporated as part of a suspension assembly.

Suspension assemblies may be used, for example, as vibration isolation mounts for a driver cabin in off-road vehicles.

Suspension units need to conform to specific functional requirements with regard to their capacity for absorbing vibration energy, and also to specific structural requirements so as to allow them to be fitted into a confined space, while maintaining capacity to withstand all operating load conditions. It is an ongoing desire to reduce the size of suspension units. United Kingdom patent document no. GB 2,242,958 discloses an elastomeric mounting of a type suitable for a vehicle cab suspension, providing good isolation of certain frequencies, but is not good for isolating sudden, shock motions. International patent application publication no. WO 2004/097246 is directed to a vibration damping system for multi-directional shock protection.

A problem with these known damping systems is that they actively damp vibrations under all conditions, i.e., large and small amplitude vibrations at all and any frequencies. Under some vibration conditions, this detracts from the effective functioning of the elastomeric device, which can compromise the performance.

Another problem with existing suspension units is that they may have been designed for vehicles or cabins without roll over protection structures (ROPS). If a vehicle is retro-fitted with a roll over protection structure or with a ROPS cabin, the suspension system may require a corresponding re-design.

However, it is costly to replace entire suspension assemblies designed for a specific environment.

### SUMMARY

Various embodiments disclosed herein alleviate the afore-mentioned problems.

Accordingly, there is disclosed a suspension module and an associated damper for use in the suspension module, the damper comprising: an inner member and an outer member, one of said members being provided for mounting to a supporting body and the other of said members being provided for mounting to a suspended body, the inner member traversing axially through a fluid-tight chamber formed between the inner member and an inner wall of the outer member, the chamber containing damper fluid; a piston axially displaceable in the chamber with respect to said inner and outer members; a permanent passage through which the damper fluid can pass from one side of the piston to the other; one of said members having a pair of abutment surfaces, one on each side of the piston, and spaced apart by a distance larger than the thickness of the piston; wherein when the piston is part way between the abutment surfaces, an auxiliary passage is open through which the damper fluid can pass from one side of the piston to the other, said auxiliary passage having an area for passage of the damper fluid that is greater than that of said permanent passage, and wherein said auxiliary passage is blocked by the piston when it abuts against either one of said abutment surfaces.

Various embodiments may comprise features described below.

### DESCRIPTION OF THE DRAWINGS

Specific embodiments shall now be described with reference to the Figures, in which:

FIG. 1 shows a cross-section of a suspension device as known in the prior art, installed in situ.

FIG. 2 shows a schematic cross-sectional view of an embodiment of a damper, in its rest position, according to an embodiment.

FIG. 3 shows a cross-section of a suspension module incorporating a damper, in its rest position, according to an embodiment.

### DETAILED DESCRIPTION

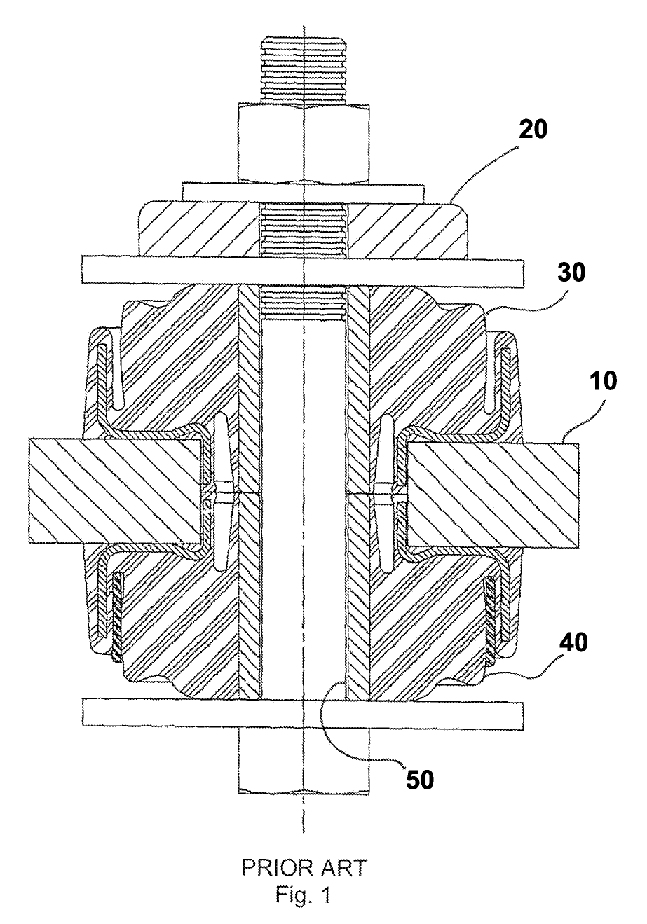

As shown in FIG. 1, a suspension device as known in the prior art is designed to moderate the transmission of vibrations from a chassis plate 10 to a plate 20. Plate 20 may be, for example, part of a bracket for a driver cabin. The suspension device of FIG. 1 comprises two axisymmetric elastomeric bodies 30 and 40 with an axial through hole for receiving a mounting bolt 50. The upper and lower elastomeric bodies are located one above and one below a mounting hole in a chassis plate 10. The elastomeric bodies are fixed to the chassis plate 10 by the bolt 50. The plate 20 is fixed to the upper elastomeric body by the same bolt 50. The damping behavior is determined by the properties of the elastomeric bodies 30, 40.

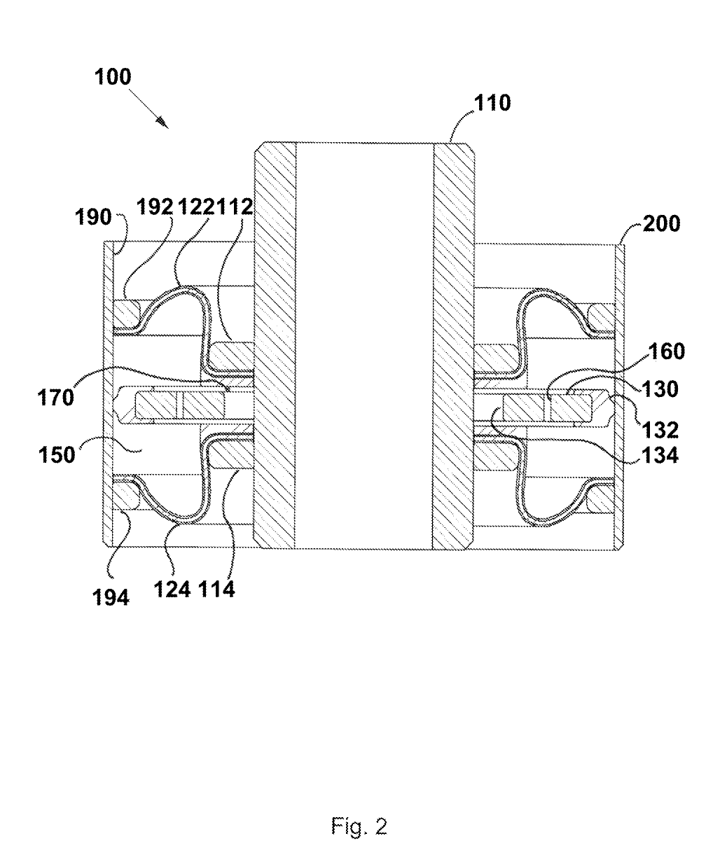

FIG. 2 shows a schematic cross-sectional view of a damper 100 for use in a suspension module in accordance with an embodiment. The damper 100 comprises an inner member 110 traversing axially though an outer member 200. One of the members 110 is provided to be mounted to a first body (e.g., a bracket of a cabin). The other of the members 200 is provided to be mounted to a second body (e.g., chassis plate 10 of FIG. 1) to which the first body is to be mounted. One of the first and second bodies generates vibration energy and it is desired to minimize the amount of vibration energy transferred from the vibration-generating body to the other body.

The inner member 110 comprises a rigid tube with a through hole to receive a mounting bolt. This facilitates the mounting of the inner member 110 to existing assembly geometries using a bolt. However, the inner member may have a different shape. For example, the inner member may be a strut with mounting means provided on one or both ends of the strut.

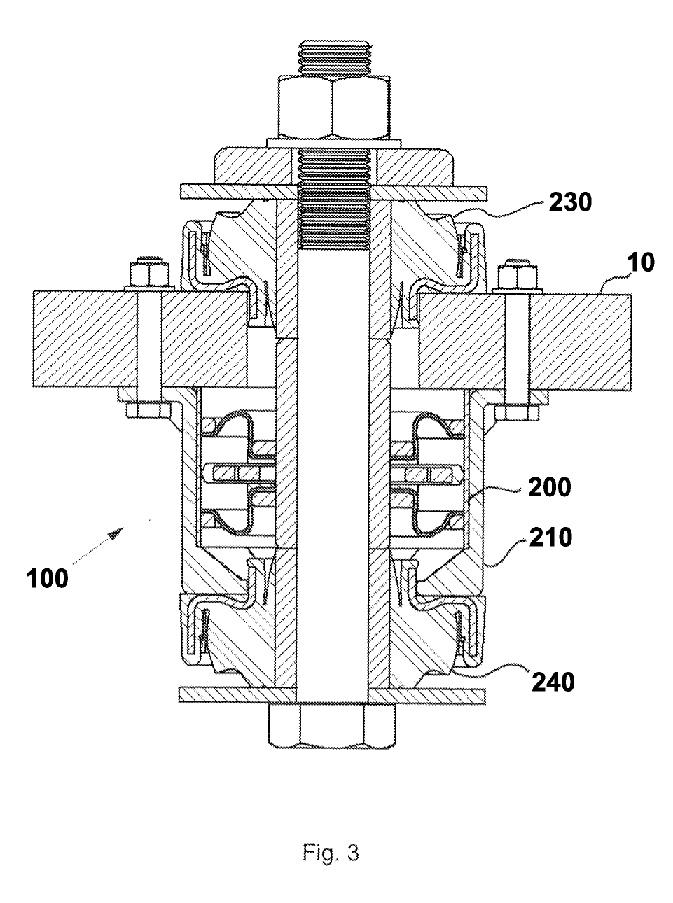

As shown in FIG. 3, the outer member 200 may be provided in the form of a cartridge to be provided within a housing 210. A modular assembly comprising a separate cartridge and housing increases the design freedom. This facilitates the integration of suspension units within existing designs, for instance for retro-fitting. However, use of a separate cartridge is not essential for the principles to be described herein.

Further shown in FIG. 2 is the inner surface 190 of the member 200, comprising upper and lower circumferential rims 192, 194. The rims facilitate manufacture, e.g., in the embodiment described below the rims provide a secure seat for a press-fitted diaphragm. In an embodiment, the rims 192, 194 are means of tethering the flexible diaphragms. For example, the rims may be folded inwards and wrapped around the outer edges of the diaphragms. The rims 192, 194 may be integral to the outer member 200. For instance, the rims may be formed by wrapping the walls over.

The inner member 110 comprises a pair of abutment surfaces, shown here in the form of upper and lower flanges 112, 114 on its outer circumference. The purpose of these abutment surfaces will be explained below. The flanges 112, 114 are spaced apart from each other by a distance that is less than the space between the rims 192, 194. Therefore, it is possible to align the pair of flanges 112, 114 about midway between the upper and lower rims 192, 194 when the inner member 110 is inserted in the outer member 200. However, it will be appreciated that the axial position of the inner member 100 relative to the outer member 200 will depend on the applied static load.

Between the inner member 110 and the outer member 200 a fluid-tight chamber 150 is defined. As shown in the embodiment of FIG. 2, the inner and outer members are connected by an upper diaphragm 122 and a lower diaphragm 124. The upper diaphragm 122 is attached to the upper rim 192 and the upper flange 112. Correspondingly, the lower diaphragm 124 is attached to the lower rim 194 and the lower flange 114. However, the diaphragms may be attached directly to the outer member 200. The attachment of the diaphragms is fluid-tight. For example, a sufficiently fluid-tight characteristic may be achieved by a press-fit. Thereby, the fluid-tight chamber 150 is defined as the volume enclosed by the outer surface of inner member 110, by the inner surface of outer member 200, and by the upper and lower diaphragms 122, 124.

The fluid-tight chamber 150 contains damper fluid. A filling port may be provided in the inner or outer member to allow damper fluid to be filled into the fluid-tight chamber 150. Preferably, the damper fluid completely fills the fluid-tight chamber 150. Preferably, the damper fluid is suitable for operation at a range of temperatures between about −25° C. to +50° C. Preferably, the damper fluid is not corrosive to the components that it comes into contact with.

The diaphragms 122, 124 comprise a flexible material allowing displacement of the inner member 110 relative to the outer member 200 while providing a fluid-tight envelope for the chamber with the total volume of the fluid-tight chamber 150 being maintained independent of said relative displacement.

While the inner and outer members are rigid, the diaphragms 122, 124 are flexible to allow multi-axial displacement of the inner member 110 relative to the outer member 200. Further, the diaphragms 122,124 should ensure that there is minimal volumetric change in response to hydraulic pressure of the damper fluid.

Although the diaphragms 122, 124 need not be press-fitted to the flanges 122, 124, this arrangement provides a secure seat of the diaphragms. The flanges 122, 124 also provide a defined seat which can facilitate alignment of the individual components during assembly of the device.

As shown in FIG. 2, in the rest position the flanges 122, 124 are mid-way between the rims 190, 192 and thus urge the diaphragms into an inclined orientation within a perimeter defined by the outer member 200. This arrangement allows each diaphragms to bulge outward, e.g. in response to axial displacement of the inner member 110.

A piston 130 is provided within the chamber 150 in the space between the pair of flanges 112, 114. The piston is shown in the form of an annular piston plate comprising an outer circumference 132 and an inner circumference 134. The outer diameter of the piston 130 is only slightly smaller than the inner diameter of outer member 200, and allows a sliding engagement with the inner surface. Thereby, the piston 130 defines within the chamber 150 an upper compartment and a lower compartment. The piston plate 130 as shown further provides a permanent fluid passage 160 allowing fluid communication between the upper and lower compartment. The permanent fluid passage 160 may be comprised within the piston 130, e.g., in the form of one or more apertures or on the form of one or more radially extending grooves.

Preferably, the inner and outer members 110, 200 are axisymmetric, and thus the chamber 150 may be described as having a generally annular or toroidal volume. In such an arrangement the piston is generally circular and able to rotate about the inner member 110. However, embodiments may have other geometries of irregular or polygonal cross-section, e.g. octagonal or hexagonal cross-section, and correspondingly shaped piston. Thereby, rotation of the piston relative to the inner member 110 is restricted.

The inner circumference 134 of the piston plate 130 is smaller than the circumference of the flanges 112, 114. As such, there is an annular overlap of the piston and the opposing axially-facing surfaces of the flanges 112, 114. Further, the piston 130 has a thickness smaller than the space between the flanges. This allows the piston 130 to be axially displaced relative to both the inner member 110 and the outer member 200. In general terms, the flanges provide abutment surfaces which limit the axial travel of the piston. In the embodiment described here, the abutment surfaces are provided by the opposing axially-facing surfaces of the flanges 112, 114. However, the abutment surfaces may be provided differently. E.g., the abutment surfaces may be formed integral with the outer or inner member.

In the embodiment of FIG. 2, the inner circumference 134 of piston plate 130 is larger than the outer circumference of the inner member 110. When the piston 130 is positioned part-way between the flanges, an auxiliary fluid passage 170 is thus open allowing fluid communication between the upper and lower compartments of the chamber 150. The area for passage of the damper fluid of the auxiliary fluid passage 170 is greater than, and in many applications substantially greater than, the area for passage of the damper fluid of the permanent fluid passage 160. When the piston plate 130 abuts either the upper or the lower flange, the auxiliary fluid passage 170 is blocked. This restricts the total area available for fluid passage to just the permanent fluid passage 170.

It is understood that in embodiments in which the abutment surfaces are not provided in the form of a pair of flanges, the inner circumference 134 of the piston 130 may be smaller than the outer circumference of inner member 110. E.g., the abutment surfaces may be provided by a circumferential groove on inner member 110, in which case the piston 130 may have a degree of axial travel within the groove. In such a configuration, the inner circumference 134 of the piston 130 may be smaller than the outer circumference of the inner member 110 and larger than the inner circumference of the groove, to provide the auxiliary passage within the groove.

In operation, at rest or under a normal vibration load, the inner member 110 may be displaced axially relative to the outer member 200 with relatively small amplitudes or speeds of displacement. While the auxiliary fluid passage 170 is open, a fluid transfer is facilitated between the upper and lower compartment, and the piston 130 can assume a position half-way, or centralized, between the flanges 112, 114. The self-centralizing effect is achieved with reference to the inner member 110 while allowing the piston 130 to be axially decoupled from the inner member 110.

A relatively large or rapid axial displacement of the inner member 110 in response to a sufficiently strong force will cause the piston 130 to abut against one the flanges 112, 114, thereby blocking the auxiliary fluid passage 170. Axial displacement with sufficient amplitude/velocity will also increase the pressure of the damper fluid on one side of the piston relative to the other side.

As long as the piston abuts against a flange, the auxiliary fluid passage 170 remains blocked. As a consequence of the blocking, the damper fluid can only pass through the permanent fluid passage 160 but cannot pass via the auxiliary fluid passage 170. Because the auxiliary fluid passage 170 makes up a significant proportion of the total area available for passage of the damper fluid, the blocking of the auxiliary fluid passage 170 means that the equilibration of pressure between the upper and lower compartment is delayed while the damper fluid is forced through the permanent fluid passage 160. This provides a damping effect that is a function of the velocity (or frequency).

To illustrate this in practice, an example is provided assuming that the inner member is mounted to a driver cabin and that the outer member is mounted to a chassis of an off-road vehicle. It will be appreciated that the weight put onto a chassis by a driver cabin will cause the inner member to move down, axially relative to the outer member. The weight of the cabin slightly increases as a driver mounts the vehicle, and the inner member may lower a bit further. During such relatively slow changes of the axial position, the piston will travel axially with the inner member, keeping the auxiliary fluid path open and self-centralizing between the abutment surfaces. As the vehicle moves, the weight distribution of the cabin may change. For instance, the angle of incline may change as the vehicle drives uphill and the local load on a damper may be temporarily reduced (or temporarily increased). This might cause the inner member to move up (or down as the load further increases), and as long as such a change in load distribution is sufficiently slow, the piston will move along axially with the inner member and remain self-centralized. However, as there is a sudden impact, the axial displacement is abrupt and the piston, being more inert in the fluid than the inner member, abuts against the abutments surfaces. This applies the damping effect, as described above.

FIG. 3 shows an embodiment in which the damper 100 is incorporated into a suspension unit akin to that shown in FIG. 1. Only one mounting plate 10 is shown for simplicity. In FIG. 3, the damper 100 is provided in the form of a cartridge seated in a housing 210. FIG. 3 shows two elastomeric bodies 230 and 240 similar to those in FIG. 1. The upper body 230 is provided above the mounting plate 10. In contrast to FIG. 1, the FIG. 3 also shows a damper 100 mounted between the lower elastomeric body 240 and the mounting plate 10. The geometry of the upper body 230 does not need to be modified to accommodate damper 100. Thus, the damper 100 can be incorporated without great difficulty. Of course, FIG. 3 provides only one example for incorporating a damper into an suspension module in accordance with an embodiment into a known suspension assembly.

It is understood that the provision of the outer member 200 in the form of a cartridge to be fitted into a housing 210 is optional, and that the outer member 200 may be the housing itself. In that case, components that are described herein with reference to the outer member 200 wall would be understood to refer to the housing 210.

The above-described embodiments comprise flanges 112, 114 which provide, in the form of axially-facing surfaces, the abutment surfaces that limit the travel of the piston. In an embodiment, a circumferential groove may be provided in one of the inner or outer members in which the piston is axially slidably disposed and wherein the travel is limited by the abutments surfaces formed by the sidewalls of the groove.

In an embodiment, the permanent fluid passage 160 comprises a groove or apertures in the abutment surfaces, allowing permanent fluid communication independent of the axial position of the piston.

The outer circumference 132 of piston 130 may comprise a resilient surface. The resilient surface allows the fluid-tight seal between the outer circumference 132 and the inner surface of the outer member 200 to be improved.

The auxiliary fluid passage 170 may be provided across the outer circumference of the piston. In that case, the outer circumference of the piston may be smaller than the circumference of the inner surface of the outer member. The abutment surfaces may, correspondingly, be provided on the inner surface of the outer member 130. In that case, the inner circumference 134 of the piston 130 may provide a fluid-tight seal with the chamber-facing surface of inner member 110. The inner circumference of the piston 130 may comprise a resilient surface to improve the fluid-tight seal.

A surface of the piston 130 may comprise a resilient surface for improved blocking of the auxiliary fluid passage.

One or both of the abutment surfaces may comprise a resilient surface for improved blocking of the auxiliary fluid passage.

What is claimed is:

1. A damper for use in a suspension module, the damper comprising:
an inner member and an outer member, one of said members being provided for mounting to a supporting body and the other of said members being provided for mounting to a suspended body, the inner member traversing axially through a fluid-tight chamber formed between the inner member and an inner wall of the outer member, the chamber containing damper fluid;
a piston axially displaceable in the chamber with respect to said inner and outer members;
a permanent passage through which the damper fluid can pass from one side of the piston to the other;
one of said members having a pair of abutment surfaces, one on each side of the piston, and spaced apart by a distance larger than the thickness of the piston;
wherein when the piston is part way between the abutment surfaces, an auxiliary passage is open through which the damper fluid can pass from one side of the piston to the other, said auxiliary passage having an area for passage of the damper fluid that is greater than that of said permanent passage, and wherein said auxiliary passage is blocked by the piston when it abuts against either one of said abutment surfaces.

2. The damper according to claim 1, wherein said abutment surfaces are surfaces of a pair of flanges.

3. The damper according to claim 1, wherein said abutment surfaces are surfaces on one of said members.

4. The damper according to claim 1, wherein a fluid-tight seal is provided between a rim of the piston and a chamber-facing wall of one of said members, and said permanent passage comprises one or more apertures in the piston.

5. The damper according to claim 1, wherein the permanent passage is provided by a space between the piston and a chamber-facing wall of one of said members.

6. The damper according to claim 1, wherein the permanent passage comprises a groove or aperture in the abutment surfaces.

7. The damper according to claim 1, wherein the fluid-tight chamber comprises a diaphragm above the piston and a diaphragm below the piston.

8. The damper according to claim 1, wherein one of the inner member or outer member comprises a filling port allowing damper fluid to be filled into the fluid-tight chamber.

9. The damper according to claim 1, wherein a surface of the piston comprises a resilient surface for improved blocking of the auxiliary fluid passage.

10. The damper according to claim 1, wherein one or both of the abutment surfaces comprises a resilient surface for improved blocking of the auxiliary fluid passage.

11. A suspension module comprising:
a damper according to claim 1; and
a housing for mounting to one of the supporting body or the suspended body, the housing being dimensioned to accommodate the outer member and comprising axial openings, the openings allowing the inner member to be mounted to the other of the supported or suspended body.

12. A kit of parts comprising:
a damper according to claim 1 that retrofits or assembles into a suspension unit.
